(19) United States
(12) Patent Application Publication
(10) Pub. No.: US 2011/0037337 A1
(43) Pub. Date: Feb. 17, 2011

(54) ROTARY ELECTROMAGNETIC MACHINES

(76) Inventor: Phillip Raymond Michael Denne, Bournemouth (GB)

Correspondence Address: HAVERSTOCK & OWENS LLP, 162 N WOLFE ROAD, SUNNYVALE, CA, 94086, US

(21) Appl. No.: 12/863,835

(22) PCT Filed: Jan. 23, 2009
(86) PCT No.: PCT/GB2009/000199

§ 371 Date: Nov. 2, 2010

(30) Foreign Application Priority Data
Jan. 24, 2008 (GB) 0801256.9
Feb. 6, 2008 (GB) 0802154.5

(51) Int. Cl. H02K 3/26

(52) U.S. Cl. 310/208

(57) ABSTRACT

A rotary electromagnetic machine is described which comprises first and second substantially cylindrical parts arranged to move relative to each other about a common axis. The first cylindrical part produces a spatially periodic radial magnetic field across an air gap, the magnetic field having a regular alternating polarity around the circumference of the first cylindrical part. The second cylindrical part comprises at least one laminar electrical conductor wrapped into cylindrical form and placed in the air gap to intercept the magnetic field, the laminar electrical conductor comprising a regular pattern of electrically conductive paths within the air gap. In more general terms, rotary motors in which the wire coils are replaced by laminations of material in which patterned conducting paths are created are described. The conducting laminations are placed in the air gap between an mature and backing iron that is constructed so as to reduce eddy current losses.

### FIELD OF INVENTION

The present invention relates to a rotary electromagnetic machine, and more particularly to a rotary electromagnetic machine having cylindrical magnetic and electrical parts which move relative to each other to provide rotary motion.

### BACKGROUND OF THE INVENTION

It is known to construct linear electric motors in a cylindrical form in which the output is a rod or tube. In such machines the magnetic part generally consists in an array of permanent magnets of disc form that produces a spatially-periodic radial magnetic field and the electrical part of such a linear motor consists in a stack of coils or electrical conductors that surround the armature along the axis of the machine and intersect the said spatially-periodic radial magnetic field. The whole assembly is generally contained within and bonded to a cylinder of mild steel that also acts as the backing iron by which the magnetic flux may complete its path. Machines of this kind are described in PCT/GB92/01277 and PCT/GB98/00495, for example.

It will be understood that, if the magnetic part of an electromagnetic machine is comprised of permanent magnets, there is a significant magnetostatic force in a radial direction between the magnetic part and the backing iron or steel casing of the electrical part. In the design of such machines, whether linear or rotary, it is therefore necessary to ensure that the radial forces are exactly balanced so as to prevent undue stress on the bearings.

If the continuous rated thrust or torque of a machine having a permanent magnet armature must be increased, it is necessary to make a proportionate increase in the mass of magnetic material used. This is not a simple matter, because there is a practical limitation on the surface area that is set by the need to sinter the most common form of permanent magnet material under great pressure.

As the unit size of a powerful permanent magnet is increased, it also becomes more dangerous to handle during the process of building the motor. It should also be noted that the increased mass of the permanent magnetic material will increase the magnetostatic forces upon the outer casing in direct proportion. It will be understood that, as the power of the machine is made greater, it is therefore of increasing importance that the armature rotates precisely about the centre line of the machine relative to the backing iron.

### SUMMARY OF INVENTION

According to one aspect of the present invention, there is provided a rotary electromagnetic machine comprising first and second substantially cylindrical parts arranged to move relative to each other about a common axis, wherein
the first cylindrical part produces a spatially periodic radial magnetic field across an air gap, the magnetic field having a regular alternating polarity around the circumference of the first cylindrical part, and
the second cylindrical part comprises at least one laminar electrical conductor wrapped into cylindrical or part cylindrical form and placed in the air gap to intercept the magnetic field, the laminar electrical conductor compromising a regular pattern of electrically conductive paths within the air gap.

The present invention relates to the design of rotary electric motors and generators in which laminar conductors are provided instead of wire coils. Wireless electrical machines of a related kind have been described in co-pending Applications GB0617989.9, GB0713408.3, PCT/GB2007/003482, GB0723349.7 and GB0801256.9.

Wireless electrical machines are physically distinguishable from those of conventional construction because the electrical conductors are not placed in slots in the backing iron that are orthogonal to the air gap (as they are in conventional machines) but instead lie in the air gap and occupy preferably almost the whole surface area of that gap. The electric current flows in patterned conducting paths that are defined by the precise removal of areas of the insulated conducting laminations. The laminations may be stacked in phases and the phases may be nested and bonded one within the other in the magnetic field region. They may be arranged to overlap one another outside that region, being bonded together to form a self-supporting structure. The width of the air gap is thereby kept small, reducing the quantity of magnetic material required to produce a given flux density across the said gap.

The spatially periodic radial magnetic field may be produced by permanently-magnetised material. In that case, the permanently-magnetised magnetic material may comprise a number of individual substantially rectangular pre-magnetised tiles, the individual pre-magnetised tiles being abutted one to another parallel to the machine axis and being interposed by shaped pole pieces. The pole pieces may be tapered radially, so as to obstruct flux leakage in a direction other than through the electrical conductors.

The complete assembly of permanent magnets and iron pole pieces may be mounted between discs of non-magnetic material and bonded to form a cylindrical armature, for example. The magnetic material is tangentially magnetised and the flux is both concentrated and redirected so that the flux emerges radially (and at increased density) from the outer periphery of each pole piece. The technique allows a large-diameter, high-torque rotary machine to be built without using any individual magnet having a dimension greater than about 15 cm.

Alternatively, the spatially periodic magnetic field may be produced by wire coils or further patterned laminar electrical conductors through which electric currents are caused to flow.

As another alternative, the spatially-periodic magnetic field may be induced by temporal variation of the currents in the conductors of the second cylindrical part. In a similar way, embodiments of the present invention may also be applied to induction machines wherein the array of permanent magnets is replaced by a simple cylinder of electrical conducting material or consists in a passive arrangement of patterned conductive laminations. In such induction machines a travelling magnetic field is produced by temporal variation of phased alternating currents in the stator conductors. Eddy currents are thereby induced in the conducting material of the armature. The interaction of the induced currents and the controlled alternating currents produces a rotary torque. Although the resulting torque is generally smaller than that which would be produced by a machine using permanent magnetic fields or using fields produced by electromagnets, an induction machine is low in cost and light in weight and may therefore offer a significant advantage in some circumstances.

At least one of the laminar electrical conductors may be made from an insulated patterned sheet, strip, ribbon or foil of conducting material.

Where plural interdigitated laminar electrical conductors are provided, these may be connected in a plurality of phases, through which electrical currents are arranged to pass, the relative signs and amplitudes of the currents being controlled so as to determine the magnitude and sign of the electromagnetic torque produced by the rotary electromagnetic machine.

To provide a rotary electromagnetic machine providing three-phase operation, the patterns of electrically conducting paths formed in the laminar electrical conductors of each phase may include conducting paths of alternating direction parallel to the axis of the motor or generator and having a regular spatial dimension equal to half that of the magnetic period.

In one embodiment, the magnetic field is produced by the armature and the electrical conductors form or are incorporated within the stator.

In another embodiment, the magnetic field is produced by the stator and the electrical conductors form or are incorporated within the armature.

The armature may be supported by at least one bearing affixed or forming part of the stator.

At least one end of the machine may have an aperture and carry a bearing through which is extended a torque tube or rod by which the rotation of the armature may be coupled to that of an external mechanism.

The patterned laminar electrical conductors of the stator may be fabricated and affixed as electrically-separate sectors around the periphery of the machine, the sectors being independently and synchronously powered and controlled.

The laminar conductors of the second cylindrical part may be insulated and made to conform to the shape of a precision mandrel.

The insulated electrical conductors have an external surface onto which iron wire may be wound, or upon which steel strip may be coiled, to provide backing iron and a path for efficient outward heat transfer whilst suppressing eddy current losses.

The pattern of electrically conducting paths formed in the laminar conductors may comprise transverse conducting paths parallel to the axis of the cylinder, and connecting conducting paths provided circumferentially at each end of the cylinder, the transverse conducting paths being interdigitated within the air gap.

Embodiments of the present invention seek to provide an economical means of constructing a rotary electrical machine in which the limitations on the diameter and mass of the individual magnets are overcome so that large torques and power outputs may be produced if required.

Furthermore, embodiments of the present invention seek to reduce the size and weight of such a machine.

The wireless electrical part of the machine consists in an assembly of patterned laminations of a conducting material (such as aluminium) that is wrapped around the axis of the armature within an outer cylinder of ferromagnetic material. It will be understood that, because each conductor lamination has a large area and replaces many individual coils and their interconnections by a single component, the use of the wireless technology increases the reliability of the motor or generator.

In one arrangement of the design, the electrical laminations may be laid upon and bonded to a thin dielectric sleeve upon a precision mandrel. The backing iron does not need to be a complete cylinder into which the electrical assembly must be fitted and bonded; it may instead be constructed by continuously winding iron wire or thin steel sheet around the conducting laminations to build up a cylindrical shell of adequate thickness. Such a fabricated shell may be bonded to the outer surface of the laminations and at a later stage the complete assembly may be fitted within an outer protective casing (which may be made from any convenient material). Casting resin may then be introduced under vacuum between the backing iron cylinder and the casing to complete the structure and to provide a thermal conducting medium.

In this way, the final assembly no longer suffers a tight constraint on the positioning of the electrical assembly in relation to the backing iron, since the backing iron is now part of the electrical assembly itself and is in good thermal contact with the electrical conductors.

It will be understood that the principles of this invention may be applied to machines in which power is supplied to the armature and in which electromagnets are used in place of permanent magnets.

It will also be understood that the method of construction of the stator is the same, whether the armature uses permanent magnets or electromagnets or whether it is replaced by a cylindrical conductor, so as to construct an induction motor.

It will be further understood that the principles of the invention may be applied to conducting laminations made of any material, including ferrous material such as iron or steel. In the latter case the resistive losses will be greater than those for a machine with (e.g) aluminium conductors. Nevertheless, there may be a significant benefit in some applications because the magnetic reluctance of the air gap will be considerably reduced, so that less magnetic material will be needed.

At least one of the laminar electrical conductors may include or support a layer of material which, when cooled below its critical temperature, becomes superconducting. By using a conducting material that consists in or is coated with a layer of superconducting material, an advantage that resistive losses may be entirely eliminated and that much higher current densities can be used to produce a large force in a small space may be achieved.

It should be noted that, when acting passively, being driven by external forces, a machine according to embodiments of the present invention will act as an electrical generator.

Various other aspect and features of the present invention are defined in the claims.

### BRIEF DESCRIPTION OF THE DRAWINGS

Embodiments of the invention will now be described, by way of example only, with reference to the accompanying drawings in which:

FIG. 1 schematically illustrates a magnetic “force unit” comprising an individual magnet fitted with pole pieces;

FIG. 2 schematically illustrates a plurality of abutted magnetic force units of the type shown in FIG. 1;

FIG. 3 schematically illustrates in axial section an armature made from such abutted pole pieces;

FIG. 4 schematically illustrates a motor including conducting laminations and the armature of FIG. 3;

FIG. 5 schematically illustrates an induction motor;

FIG. 6 schematically illustrates a conducting lamination for a three-phase wireless motor;

FIG. 7 schematically illustrates how the conducting lamination of FIG. 6 can be wrapped into a cylinder for a linear cylindrical motor; and

FIG. 8 schematically illustrates how the conducting lamination of FIG. 6 can be wrapped into a cylinder for a rotary cylindrical motor;

FIG. 9 schematically illustrates the conducting lamination of FIGS. 6 and 8 can be interdigitated with another conducting lamination.

### DESCRIPTION OF EXAMPLE EMBODIMENTS

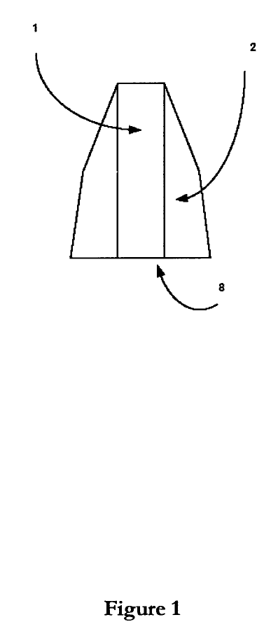

FIG. 1 schematically illustrates how magnets 1 are fitted between tapered pole pieces 2, so as to concentrate the flux and redirect it radially outwards via conducting laminations. It will be understood that the outer surfaces 8 of the magnet and polepieces (here shown flat) can be curved to conform to the bounding cylinder of the armature.

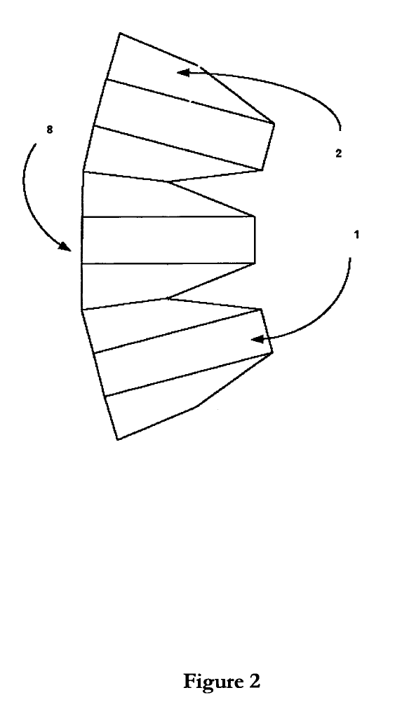

FIG. 2 shows how the force units of FIG. 1 may be abutted to encircle a torque tube (not shown). It will be understood that the taper angle of the pole piece is matched to the number of force units around the torque tube. Again, the outer facet edges 8 of the polepieces 2 and magnets 1 can also be curved to match the bounding cylinder of the armature.

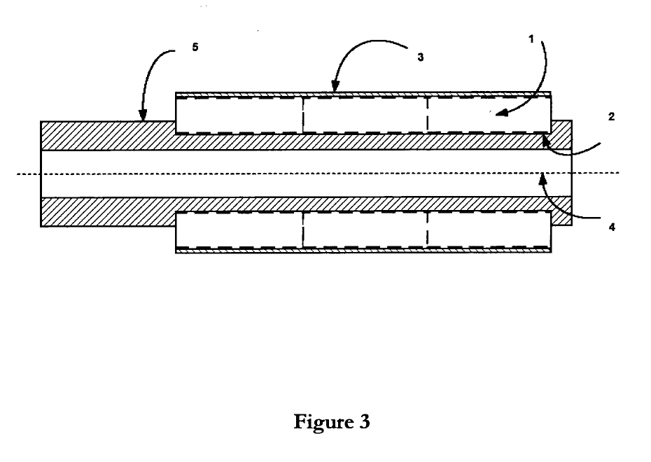

FIG. 3 shows an axial section of the armature, indicating how the magnets 1 are abutted along the length of each pole piece 2. Every force unit experiences a strong magnetostatic force radially outwards across the air gap and it is therefore necessary for the complete assembly to be restrained by a bounding cylinder 3, which may, for example, be made of a non-ferrous metal or from one or more wound layers of a strong fibre. The force units are also keyed into slots in the torque tube 5, which rotates around the central axis 4.

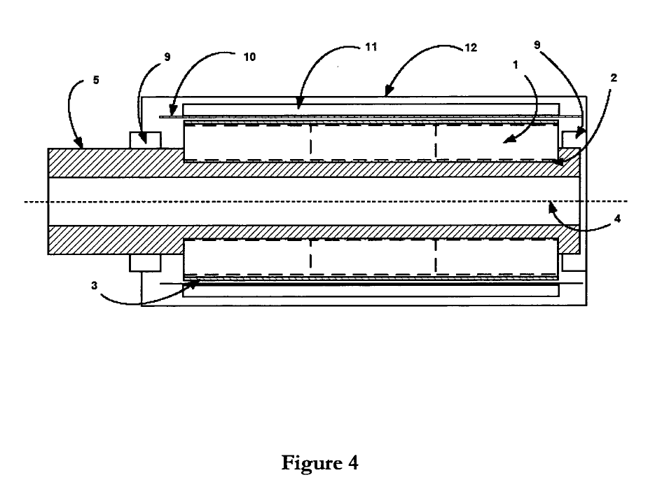

FIG. 4 shows an axial section of the complete motor including conducting laminations 10 and backing iron 11. The whole assembly is fitted within a motor casing 12, which carries bearings 9 supporting the torque tube 5. It will be understood that the proportions of the motor here shown are for diagrammatical convenience only and that the machine may be constructed according to the same invention, but having an axial length much smaller than its outer diameter. Such a large diameter high-torque motor would be suitable for actuation of ships stabilisers or steering gear, for example.

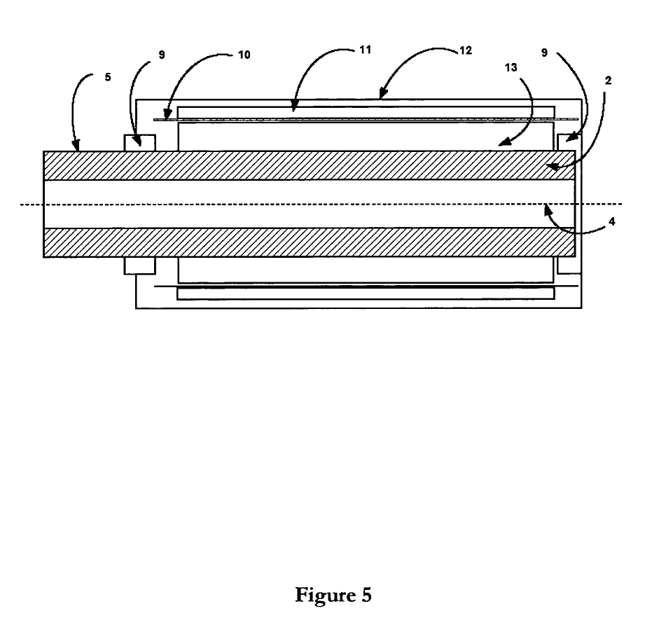

FIG. 5 shows an axial cross section of an induction motor according to an embodiment of the invention, in which the stator assembly is as for FIG. 4, but in which the armature has no permanent magnets 1, pole pieces 2 or containing cylinder 3. The armature here consists only of a conducting cylinder 13, in which currents are induced to flow by a rotating field in the stator 10, 11.

It will be understood that such an induction based machine, though less efficient, is much lower in cost than the permanent-magnet, brushless three-phase motor earlier described.

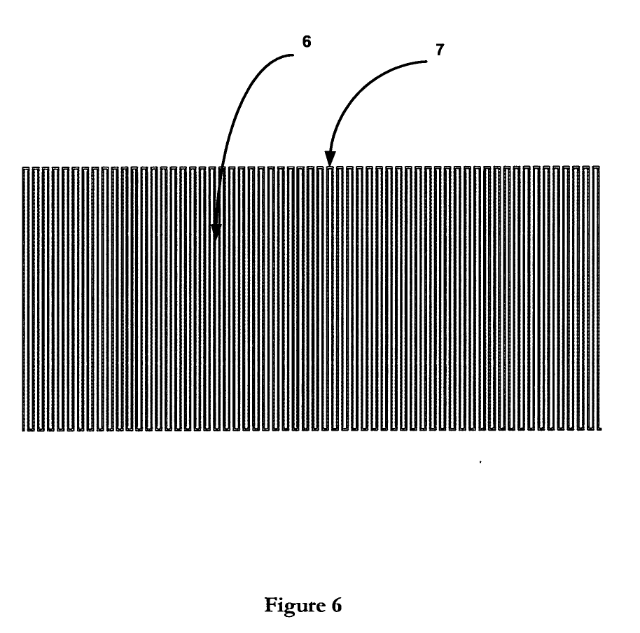

FIG. 6 shows a basic conducting lamination for a three-phase wireless motor in which the transverse conducting paths 6 alternate in direction and are connected by orthogonal conducting paths 7. The surfaces of the lamination may be insulated by an anodising process or by painting with varnish, for example.

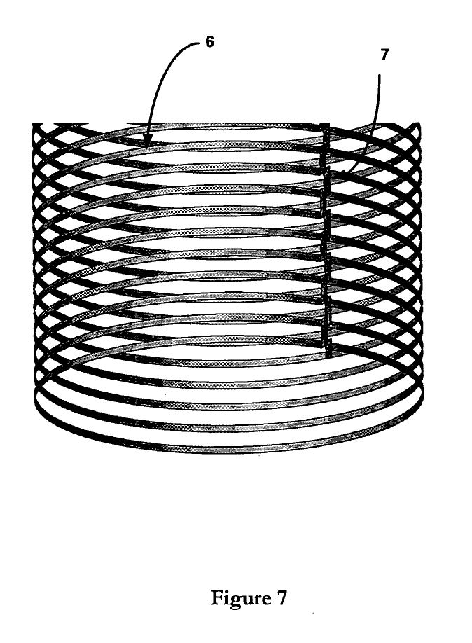

FIG. 7 shows how such an insulated lamination may be formed into a cylinder for use in a linear wireless motor such as that described in co-pending Application GB0801256.9. In that case the transverse conducting paths 6 are circumferential and the connecting paths 7 are parallel to the axis of the motor and lie within the volume of the backing iron.

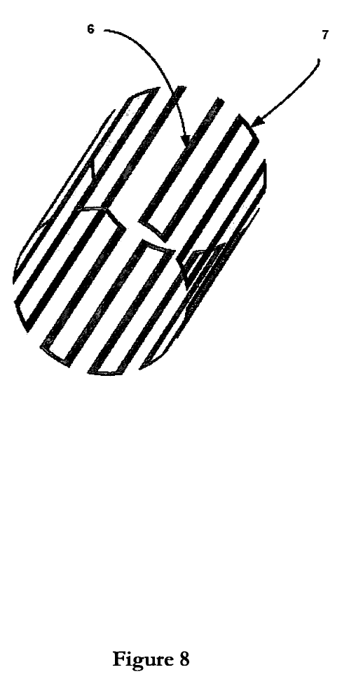

FIG. 8 shows how the same type of lamination may be formed into a cylinder for use in a rotary motor. In an embodiment of the present invention, the alternating transverse conducting paths 6 are parallel to the axis of the machine, whilst the connecting paths 7 are circumferential at the ends of the motor and clear of the backing iron. For large rotary machines it may be an advantage for the formed laminations to be divided into a plurality of sectors around the circumference of the complete machine, so that each sector may be independently (but synchronously) powered at a lower voltage.

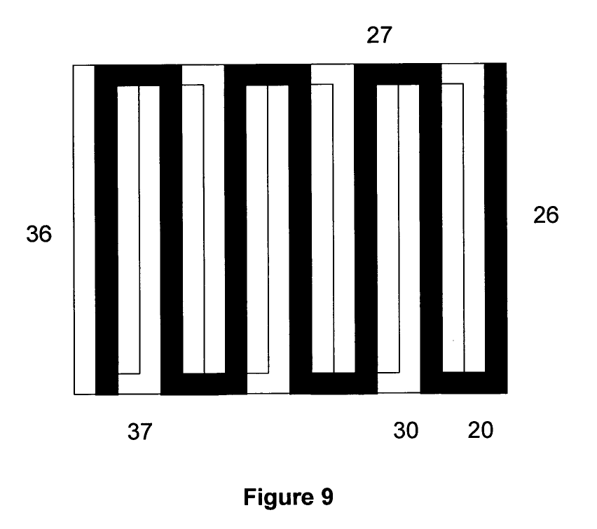

FIG. 9 shows how the conducting lamination of FIGS. 6 and 8 can be interdigitated with another conducting lamination. In particular, in the example of FIG. 9, a conducting lamination 20 and a conducting lamination 30 are shown to be overlapped. The conducting lamination 20 comprises transverse conducting paths 26 and connecting paths 27. The conducting lamination 30 comprises transverse conducting paths 36 and connecting paths 37. As can be seen from FIG. 9, the connecting paths 27 and 37 overlap, and may be bonded at the points of overlap. In contrast, the transverse conducting paths 26 and 36 do not overlap, and are in fact shaped or bent so as to be interdigitated (nested) together within a plane. The conducting laminations can then be wrapped into a cylinder as per FIG. 8. It will be appreciated that more than two laminar conductors can be nested in this way. For example, in the case of a three-phase machine, three laminar conductors would be interdigitated in this way.

The principal advantages provided by embodiments of the present invention include the following:
By the use of tapered pole pieces fitted with pre-magnetised segments and arranged in a ring of any chosen diameter, the mass of magnetic material can be increased as required, so as to improve the continuously-rated torque of a rotary motor.
The mass of the electrical part of such a machine can be reduced by the replacement of copper wire with laminar aluminium conductors.
The manufacturing cost may be greatly reduced by eliminating the work of winding and assembling a large number of coils and of bonding them into the mechanical structure.
The manufacturing quality and the operational reliability of the machine may be increased by the corresponding reduction in complexity.
Because the rate of heat flow from the flat surfaces of the conducting laminations is greater than that from a wire bundle, the machine can be driven harder than a conventional coil-wound machine.
The aluminium conductors may be insulated by an anodising process, which is simple and provides a robust insulating coating that will withstand high temperature operation if necessary.
The construction of the backing iron, by winding iron wire or thin steel strip to achieve the required thickness, reduces eddy current losses that would otherwise be induced in a solid cylindrical casing.
The technology is fully scaleable and may be applied to electrical machines having a wide range of sizes and power outputs.

Various further aspects and features of the present invention are defined in the appended claims. Various modifications can be made to the embodiments herein before described without departing from the scope of the present invention.

1. A rotary electromagnetic machine comprising first and second substantially cylindrical parts arranged to move relative to each other about a common axis, wherein
the first cylindrical part produces a spatially periodic radial magnetic field across an air gap, the magnetic field having a regular alternating polarity around the circumference of the first cylindrical part, and
the second cylindrical part comprises a plurality of laminar electrical conductors wrapped into cylindrical or part cylindrical form and placed in the air gap to intercept the magnetic field, each of the laminar electrical conductors compromising a regular pattern of electrically conductive paths, the electrically conductive paths of the plurality of laminar electrical conductors being interdigitated and nested within the air gap to occupy almost the whole surface area of the air gap;
wherein the patterns of electrically conducting paths formed in each of the laminar electrical conductors include conducting paths of alternating direction parallel to the common axis, each pattern having a regular spatial dimension equal to half that of the magnetic period; and
wherein the pattern of electrically conducting paths formed in the laminar conductors comprise transverse conducting paths provided axially along the cylindrical form, and connecting conducting paths provided circumferentially about the cylindrical form, the transverse conducting paths being interdigitated and nested within the air gap.

2. (canceled)

3. A rotary electromagnetic machine according to claim 1, wherein the plurality of laminar electrical conductors of the second part are overlaid, interdigitated and bonded to form an integral mechanical structure.

4. A rotary electromagnetic machine according to claim 1, wherein the spatially periodic radial magnetic field is produced by permanently-magnetised material.

5. A rotary electromagnetic machine according to claim 4, wherein the permanently-magnetised magnetic material is extended in length by the use of a number of individual substantially rectangular pre-magnetised tiles, the individual pre-magnetised tiles being abutted one to another and being mounted between two shaped pole pieces.

6. A rotary electromagnetic machine according to claim 5, wherein the pole pieces are tapered radially, so as to inhibit flux leakage in a direction other than through the electrical conductors.

7. A rotary electromagnetic machine according to claim 3, wherein the spatially periodic magnetic field is produced by wire coils or further patterned laminar electrical conductors through which electric currents are caused to flow.

8. A rotary electromagnetic machine according to claim 3, wherein the spatially-periodic magnetic field is induced by temporal variation of the currents in the conductors of the second cylindrical part.

9. A rotary electromagnetic machine according to claim 3, wherein at least one of the laminar electrical conductors is made from an insulated patterned sheet, strip, ribbon or foil of conducting material.

10. A rotary electromagnetic machine according to claim 1, wherein the laminar electrical conductors are connected in a plurality of phases, through which electrical currents are arranged to pass, the relative signs and amplitudes of the currents being controlled so as to determine the magnitude and sign of the electromagnetic torque produced by the rotary electromagnetic machine.

11. A rotary electromagnetic machine according to claim 10, wherein the machine provides three-phase operation.

12. A rotary electromagnetic machine according to claim 1, wherein the magnetic field is produced by the armature and the electrical conductors form or are incorporated within the stator.

13. A rotary electromagnetic machine according to claim 1, wherein the magnetic field is produced by the stator and the electrical conductors form or are incorporated within the armature.

14. A rotary electromagnetic machine according to claim 1, wherein the armature is supported by at least one bearing affixed or forming part of the stator.

15. A rotary electromagnetic machine according to claim 14, wherein at least one end of the machine has an aperture and carries a bearing through which is extended a torque tube or rod by which the rotation of the armature may be coupled to that of an external mechanism.

16. A rotary electromagnetic machine according to claim 1, wherein the patterned laminar electrical conductors of the stator are fabricated and affixed as electrically-separate sectors around the periphery of the machine, the sectors being independently and synchronously powered and controlled.

17. A rotary electromagnetic machine according to claim 1, wherein the laminar conductors of the second cylindrical part are insulated and are made to conform to the shape of a precision mandrel.

18. A rotary electromagnetic machine according to claim 17, wherein the electrical conductors have an external insulated surface or sheath onto which iron wire is wound, or upon which steel strip is coiled, to provide backing iron and a path for efficient outward heat transfer.

19. A rotary electromagnetic machine according to claim 1, wherein at least one of the laminar electrical conductors includes or supports a layer of material which, when cooled below its critical temperature, becomes superconducting.

20. A rotary electromagnetic machine according to claim 1, wherein at least one of the laminar electrical conductors is fabricated from ferromagnetic material.

21. (canceled)
